(19) United States
(12) Patent Application Publication
(10) Pub. No.: US 2013/0076364 A1
(43) Pub. Date: Mar. 28, 2013

(54) BATTERY DETECTION METHOD

(71) Applicants: Lien-Hsun Ho, Taipei (TW); Yuan-Liang Hsu, Taipei (TW); Cheng-Wei Chu, Taipei (TW)

(72) Inventors: Lien-Hsun Ho, Taipei (TW); Yuan-Liang Hsu, Taipei (TW); Cheng-Wei Chu, Taipei (TW)

(21) Appl. No.: 13/240,343

(22) Filed: Sep. 22, 2011

(51) Int. Cl. G01N 27/416

(52) U.S. Cl. 324/433

(57) ABSTRACT

A battery detection method detecting if a voltage to be tested falls within a voltage range between a highest voltage of a rechargeable battery and a highest detection voltage. If the voltage to be tested is less than the highest detection voltage, further determine if the voltage to be tested reaches a target voltage within a test time period. If the voltage to be tested reaches the target voltage after the test time period expires, determine that the voltage to be tested is from a rechargeable battery. If the voltage to be tested reaches the target voltage within the test time period, determine that the voltage to be tested is from a non-rechargeable battery. Accordingly, the battery detection method can easily detect if a voltage to be tested is from a rechargeable battery.

### BACKGROUND OF THE INVENTION

1. Field of the Invention

The present invention relates to a battery detection method, and more particularly to a method detecting whether a battery is a rechargeable battery or not.

2. Description of the Related Art

Batteries in the market can be classified into rechargeable batteries and non-rechargeable batteries in terms of feasibility of power storage. When the power capacity of a rechargeable battery is exhausted, the rechargeable battery can be connected to a charger so that the charger charges the rechargeable battery and the rechargeable battery can be reused after being charged. The non-rechargeable batteries, such as carbon zinc batteries or alkaline batteries, are not allowable to be charged for sake of chemical properties thereof. If forcibly charged, the non-rechargeable batteries may lead to conditions such as liquid leakage, explosion or the like, not only damaging batteries themselves and the chargers but also jeopardizing users' safety.

### SUMMARY OF THE INVENTION

An objective of the present invention is to provide a battery detection method detecting whether a battery is a rechargeable battery or not.

To achieve the foregoing objective, the battery detection method has steps of:

determining if a voltage to be tested is less than a highest voltage of a rechargeable battery;

determining if the voltage to be tested is less than a maximum detection voltage if the voltage to be tested is less than the highest voltage of the rechargeable battery;

determining if the voltage to be tested reaches the target voltage within the test time period if the voltage to be tested is less than the maximum detection voltage; determining that the voltage to be tested is from a rechargeable battery if the voltage to be tested reaches the target voltage after the test time period expires; and

determining that the voltage to be tested is from a non-rechargeable battery if the voltage to be tested reaches the target voltage within the test time period.

The battery detection method can be applied to a battery charger. When the battery charger is loaded with a battery to be tested and the battery outputs a voltage to be tested, the battery detection method can instantly detect the type of the battery to be tested in accordance with the voltage to be tested. If the battery to be tested is a non-rechargeable battery, charging of the battery to be tested is stopped to avoid fluid leakage and explosion of the non-rechargeable battery.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a charge control device in accordance with the present invention;

FIG. 2 is a flow diagram of a battery detection method in accordance with the present invention; and

FIG. 3 is a flow diagram of a step of the battery detection method in FIG. 2 for determining if a tested voltage is from a rechargeable battery or a non-rechargeable battery.

### DETAILED DESCRIPTION OF THE INVENTION

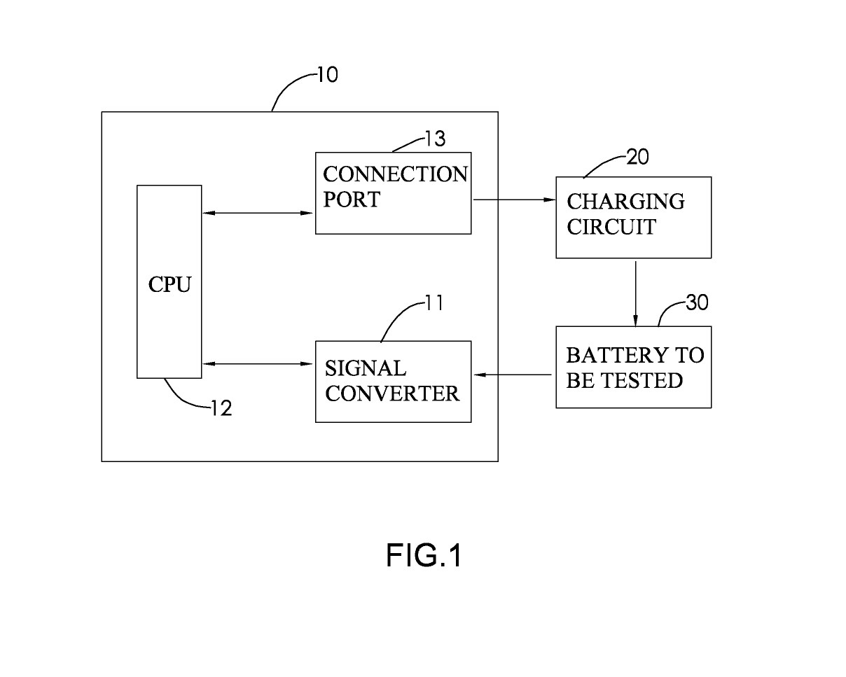

With reference to FIG. 1, a charge control device in accordance with the present invention has a control module 10 and a charging circuit 20.

The control module 10 has a signal converter 11, a CPU 12 and a connection port 13. The signal converter 11 may be an analog to digital (A/D) converter having an input terminal and an output terminal. The input terminal is electrically connected to a battery to be tested 30 to receive a voltage to be tested outputted from the battery to be tested 30. The voltage to be tested is converted by the signal converter 11 into a digital signal and then is outputted from the output terminal.

The CPU 12 is electrically connected to the output terminal of the signal converter 11 to receive the digital signal outputted from the signal converter 11. The CPU 12 has a detection procedure embedded therein for outputting a control signal by determining a type of the battery to be tested 30 in accordance with the voltage to be tested. In the present embodiment, the CPU determines if the battery to be tested is a rechargeable battery or a non-rechargeable battery. If the battery to be tested is the rechargeable battery, the CPU outputs a charge control signal. If the battery to be tested is the non-rechargeable battery, the CPU outputs a no-charge control signal.

The connection ports 13 may be a general purpose I/O (GPIO) electrically connected to the CPU 12 for receiving and transmitting out the charge control signal or the no-charge control signal.

The charging circuit 20 is electrically connected to the battery to be tested 30 and the connection port 13 of the control module 10 to receive the charge control signal or the no-charge control signal. If receiving a charge control signal, the charging circuit 20 outputs a charging power to charge the battery to be tested 30. If receiving a no-charge control signal, the charging circuit 20 stops outputting the charging power to charge the battery to be tested 30.

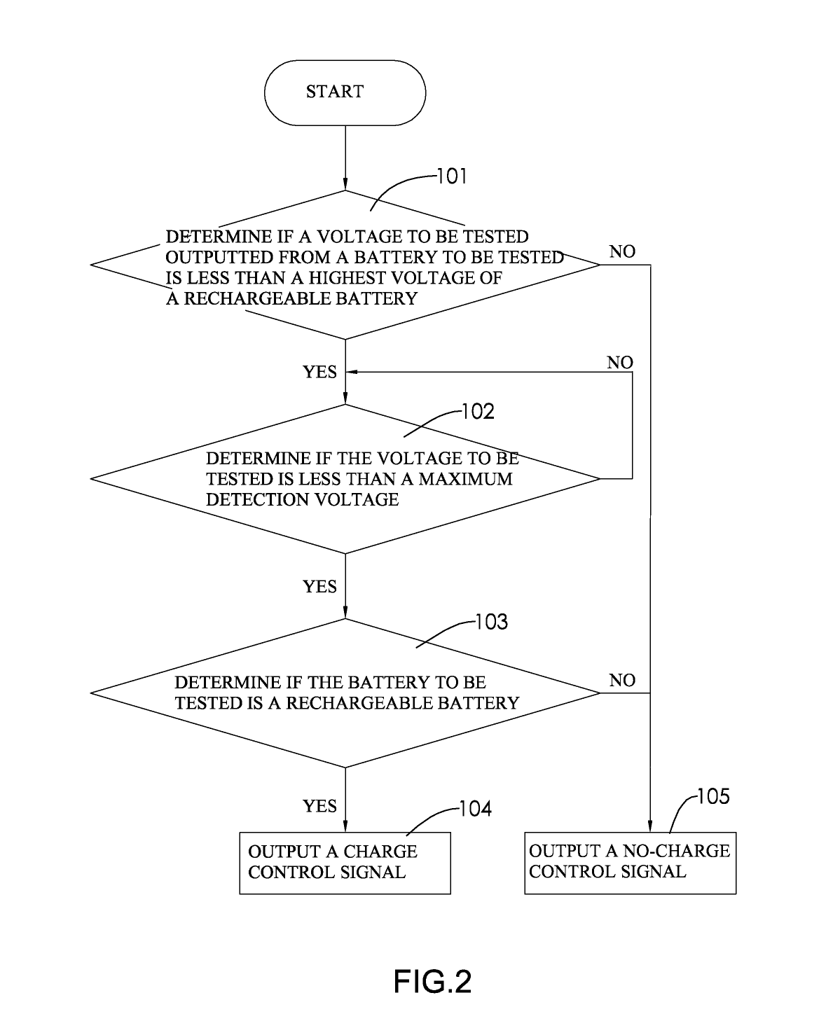

With reference to FIG. 2, a battery detection method in accordance with the present invention has the following steps.

Step 101: Determine if a voltage to be tested outputted from a battery to be tested is less than a highest voltage of a rechargeable battery. As the output voltage, for example 1.2V, of a regular rechargeable battery, for example a nickel metal hydride battery, is relatively less than the output voltage, for example 1.5V, of a non-rechargeable battery, for example an alkaline battery, the output voltage of the regular rechargeable battery is taken as the highest voltage of the rechargeable battery and serves as a criterion for preliminarily determining if the battery to be tested 30 is a non-rechargeable battery. The highest voltage of the rechargeable battery can be selected by users.

If the voltage to be tested is greater than the highest voltage of the rechargeable battery, the battery to be tested 30 outputting the voltage to be tested is determined to be a non-rechargeable battery. After the battery to be tested 30 is determined to be the non-rechargeable battery, a no-charge control signal is outputted so that the charging circuit stops charging the battery to be tested 30.

Step 102: Determine if the voltage to be tested is less than a maximum detection voltage if the voltage to be tested is less than the highest voltage of the rechargeable battery. The maximum detection voltage indicates a threshold voltage of a regular rechargeable battery below which the regular rechargeable battery needs to be charged, and the maximum detection voltage can be selected by users. For example, for a rechargeable battery having a rated output voltage 1.2V, users can select 0.8V as the maximum detection voltage therefor. When the output voltage of the rechargeable battery is lower than 0.8V, it represents that the rechargeable battery has a low power capacity and needs to be charged again.

If the voltage to be tested is greater than the maximum detection voltage (i.e. the voltage to be tested is greater than the maximum detection voltage and less than the highest voltage of the rechargeable battery), it indicates that the battery to be tested 30 has a nearly saturated power capacity. However, when the power capacity of the battery to be tested 30 is at a nearly saturated state, it is difficult to determine if the battery to be tested 30 is a rechargeable battery or a non-rechargeable battery. To accurately detect the battery type, the voltage to be tested needs to be continuously determined if it is less than the maximum detection voltage until the battery to be tested 30 discharges to have the voltage to be tested lower than the maximum detection voltage.

Step 103: Determine if the battery to be tested 30 is a rechargeable battery. When the voltage to be tested is less than the maximum detection voltage, it represents that the battery to be tested 30 has an insufficient power capacity and needs to be charged. Before the battery to be tested 30 is charged, the battery to be tested 30 needs to be verified as a rechargeable battery because the battery type of the battery to be tested 30 is not certain yet.

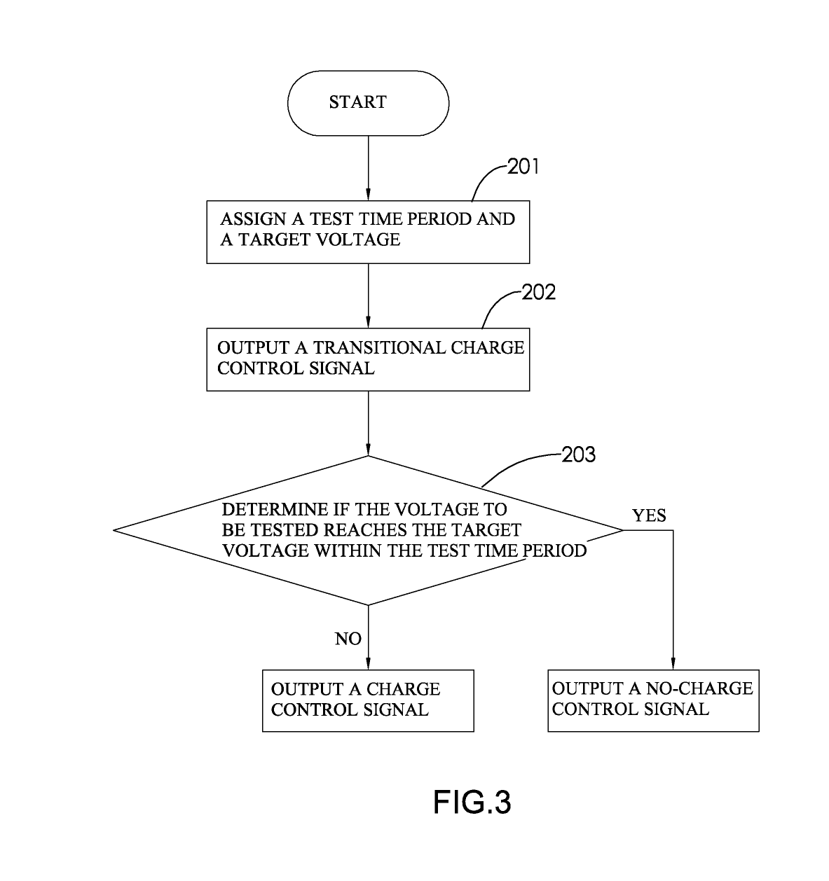

As the internal resistance of a regular rechargeable battery is greater than that of a regular non-rechargeable battery, the charging speed of the regular rechargeable battery is slower than that of the regular non-rechargeable battery. With reference to FIG. 3, based on such characteristic, the aforementioned Step 103 is implemented in a more detailed fashion by the following steps.

Step 201: Assign a test time period and a target voltage. The CPU 12 can assign the test time period and the target voltage based on a charging speed of a regular rechargeable battery.

Step 202: Output a transitional charge control signal. After Step 201, instruct the charging circuit 20 to output a transitional charge control signal for the purpose of charging the battery to be tested within the test time period and determining if the charging speed of the battery to be tested is slower than that of a regular non-rechargeable battery or the test time period.

Step 203: Determine if the voltage to be tested reaches the target voltage within the test time period. If the voltage to be tested reaches the target voltage after the test time period expires, the CPU 12 determines that the battery to be tested 30 is the rechargeable battery. On the other hand, if the voltage to be tested reaches the target voltage within the test time period, it represents that the internal resistance of the battery to be tested is smaller and the resulting charging speed is faster. In view of the smaller internal resistance, the CPU 12 determines that the voltage to be tested is outputted from a non-rechargeable battery.

Step 104: Output a charge control signal if the voltage to be tested is determined to be from the rechargeable battery in Step 103 or Steps 201-203. After receiving the charge control signal, the charging circuit 20 starts charging the battery to be tested.

Step 105: Output a no-charge control signal if the voltage to be tested is determined to be from a non-rechargeable battery in Step 103 or Steps 201-203. After receiving the no-charge control signal, the charging circuit 20 stops charging the battery to be tested.

Before executing Step 103 for determining if the battery to be tested 30 is a rechargeable battery, the CPU 12 first preliminarily determines if the voltage to be tested outputted from the battery to be tested 30 falls within a voltage range between the maximum detection voltage and the highest voltage of the rechargeable battery. If the voltage to be tested is greater than the highest voltage of the rechargeable battery, the battery to be tested 30 is a non-rechargeable battery and can be ruled out preliminarily. If the voltage to be tested falls within the foregoing voltage range, it represents that the battery to be tested 30 has a saturated power capacity and is difficult to be determined to which battery type it pertains. Hence, the CPU 12 constantly determines if the voltage to be tested is less than the maximum detection voltage. The battery type is not determined until the battery to be tested 30 discharges to have the voltage to be tested lower than the maximum detection voltage. Therefore, the accuracy in determining battery type can be effectively raised and the determination error is significantly reduced.

Given the detection device and detection method of the present invention, a battery to be tested can be detected as a rechargeable battery or a non-rechargeable battery. If determined to be a rechargeable battery, the charging circuit starts charging the battery to be tested. On the other hand, if determined to be a non-rechargeable battery, the charging circuit stops charging the battery to be tested. The occurrence of liquid leakage and explosion associated with the battery can be avoided. As the output voltages and charging speeds of rechargeable batteries vary with the models thereof, users can adjust the highest voltage, the maximum detection voltage, the test time period and the target voltage of each rechargeable battery to be tested through the present invention to determine if the battery to be tested is a rechargeable battery.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A battery detection method comprising steps of:
determining if a voltage to be tested is less than a highest voltage of a rechargeable battery;
determining if the voltage to be tested is less than a maximum detection voltage if the voltage to be tested is less than the highest voltage of the rechargeable battery;
if the voltage to be tested is less than the maximum detection voltage, determining if the voltage to be tested reaches a target voltage within a test time period;
determining that the voltage to be tested is from the rechargeable battery if the voltage to be tested reaches the target voltage after the test time period expires; and
determining that the voltage to be tested is from a non-rechargeable battery if the voltage to be tested reaches the target voltage within the test time period.

2. The battery detection method as claimed in claim 1 further comprising a step of outputting a charging power to increase the voltage to be tested so as to determine if the target voltage is reached within the test time period when the voltage to be tested is less than the maximum detection voltage.

3. The battery detection method as claimed in claim 1 further comprising a step of determining that the voltage to be tested is from a non-rechargeable battery if the voltage to be tested is greater than the highest voltage of the rechargeable battery.

4. The battery detection method as claimed in claim 2 further comprising a step of determining that the voltage to be tested is from a non-rechargeable battery if the voltage to be tested is greater than the highest voltage of the rechargeable battery.

5. The battery detection method as claimed in claim 1 further comprising a step of continuously determining if the voltage to be tested is less than the maximum detection voltage if the voltage to be tested is greater than the maximum detection voltage in the step of determining if the voltage to be tested is less than a maximum detection voltage until the voltage to be tested is less than the maximum detection voltage.

6. The battery detection method as claimed in claim 2 further comprising a step of continuously determining if the voltage to be tested is less than the maximum detection voltage if the voltage to be tested is greater than the maximum detection voltage in the step of determining if the voltage to be tested is less than a maximum detection voltage until the voltage to be tested is less than the maximum detection voltage.

7. The battery detection method as claimed in claim 3 further comprising a step of continuously determining if the voltage to be tested is less than the maximum detection voltage if the voltage to be tested is greater than the maximum detection voltage in the step of determining if the voltage to be tested is less than a maximum detection voltage until the voltage to be tested is less than the maximum detection voltage.

8. The battery detection method as claimed in claim 4 further comprising a step of continuously determining if the voltage to be tested is less than the maximum detection voltage if the voltage to be tested is greater than the maximum detection voltage in the step of determining if the voltage to be tested is less than a maximum detection voltage until the voltage to be tested is less than the maximum detection voltage.
